(19) United States
(12) Patent Application Publication
(10) Pub. No.: US 2024/0250276 A1
(43) Pub. Date: Jul. 25, 2024

(54) SEPARATOR FOR FUEL CELL AND FUEL CELL STACK

(71) Applicant: TOYOTA BOSHOKU KABUSHIKI KAISHA, Aichi-ken (JP)

(72) Inventor: Haruyuki AONO, Aichi-ken (JP)

(73) Assignee: TOYOTA BOSHOKU KABUSHIKI KAISHA, Aichi-ken (JP)

(21) Appl. No.: 18/410,247

(22) Filed: Jan. 11, 2024

(30) Foreign Application Priority Data
Jan. 23, 2023 (JP) 2023-007994

(51) Int. Cl. H01M 8/026; H01M 8/0267; H01M 8/2483

(52) U.S. Cl. CPC H01M 8/026; H01M 8/0267; H01M 8/2483

(57) ABSTRACT

A separator for a fuel cell includes multiple main passages configured to face a power generating unit and allow reactant gas to flow through the main passages, a supply-side manifold hole configured to supply the reactant gas toward the main passages, a discharge-side manifold hole configured to discharge the reactant gas from the main passages, multiple supply-side connecting passages that connect the supply-side manifold hole and the main passages to each other, and multiple discharge-side connecting passages that connect the discharge-side manifold hole and the main passages to each other. At least one of the supply-side connecting passages and the discharge-side connecting passages has a protrusion that protrudes toward the power generating unit, the protrusion being partially provided in an extending direction of the connecting passage.

### BACKGROUND

### 1. Field

The present disclosure relates to a separator for a fuel cell and a fuel cell stack.

### 2. Description of Related Art

Japanese Laid-Open Patent Publication No. 2022-178919 discloses a fuel cell stack that is formed by stacking multiple single cells. Each single cell includes a power generating unit and two separators that hold the power generating unit between them. Each separator includes a supplying hole and a discharging hole that extend through the separator in a stacking direction of the single cell. Reactant gas flows through the supplying hole and the discharging hole. One of the surfaces of each separator that includes a facing surface, which faces the power generating unit, includes passage grooves through which reactant gas flows and ribs arranged between adjacent passage grooves. Each passage groove includes a main passage, which is provided on the facing surface, a supply-side connecting passage, which connects the supplying hole and the main passage to each other, and a discharge-side connecting passage, which connects the main passage and the discharging hole to each other. Each separator includes a metal base. The base is formed by stamping.

In such a fuel cell stack, when the base of the separator is stamped, a portion surrounding the supplying hole, a portion surrounding the discharging hole, and the passage grooves are particularly largely deformed. This is likely to produce residual stress in the base of the separator. As a result, the separator may be warped.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a separator for a fuel cell is configured to face a power generating unit of the fuel cell. The separator includes multiple main passages configured to face the power generating unit and allow reactant gas to flow through the main passages, a supply-side manifold hole configured to supply the reactant gas toward the main passages, a discharge-side manifold hole configured to discharge the reactant gas from the main passages, multiple supply-side connecting passages that connect the supply-side manifold hole and the main passages to each other, and multiple discharge-side connecting passages that connect the discharge-side manifold hole and the main passages to each other. At least one of the supply-side connecting passages and the discharge-side connecting passages has a protrusion that protrudes toward the power generating unit, the protrusion being partially provided in an extending direction of the connecting passage.

In another general aspect, a fuel cell stack includes stacked single cells. Each single cell includes a power generating unit, a first separator, and a second separator. The first and second separators hold the power generating unit between the first and second separators. The first separator of each single cell is adjacent to the second separator of another single cell. At least one of the first separator and the second separator is the separator for the fuel cell and includes a cooling passage on a surface opposite to a surface on which the main passages are provided. The cooling passage is configured to allow coolant to flow through the cooling passage. The cooling passage is located between an adjacent pair of the connecting passages. The protrusion is provided over an entire width of the at least one of the connecting passages. A groove is provided on the surface opposite to the surface on which the main passages are provided. The groove is formed by the protrusion and connecting an adjacent pair of the cooling passages to each other.

Other features and aspects will be apparent from the following detailed description, the drawings, and the claims.

### BRIEF DESCRIPTION OF THE DRAWINGS

FIG. 1 is an exploded perspective view of a single cell of a fuel cell stack according to one embodiment.

FIG. 2 is a plan view of a cathode-side separator shown in FIG. 1.

FIG. 3 is a cross-sectional view taken along line 3-3 of FIG. 2, mainly showing the cathode-side separator and an anode-side separator of another single cell that is adjacent to the single cell including the cathode-side separator.

FIG. 4 is a cross-sectional view taken along line 4-4 of FIG. 2.

FIG. 5 is a cross-sectional view showing a protrusion according to a modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

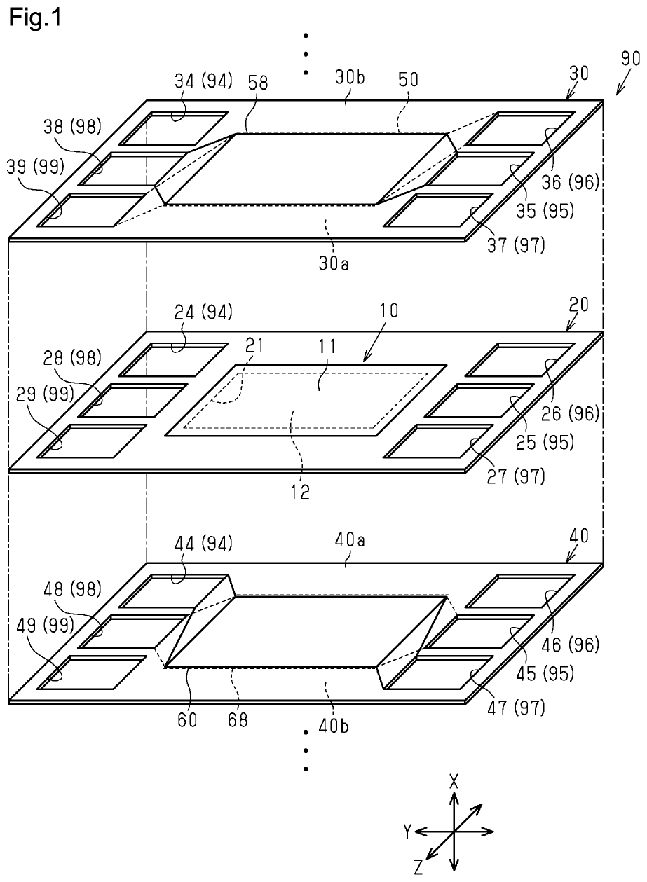

A separator for a fuel cell and a fuel cell stack according to an embodiment will now be described with reference to FIGS. 1 to 4. For illustrative purposes, some parts of the structures in the drawings are exaggerated or simplified, and the dimensional ratios of the structures may be different from the actual ratios.

As shown in FIG. 1, the fuel cell stack includes multiple single cells 90 stacked together.

### Single Cell 90

Each single cell 90 includes a membrane electrode gas diffusion layer assembly (hereinafter, referred to as a power generating unit 10), a frame member 20, which has an electrical insulation property and surrounds the power generating unit 10, a cathode-side separator 30, and an anode-side separator 40. The cathode-side separator 30 and the anode-side separator 40 hold the power generating unit 10 and the frame member 20 in between. The single cell 90 is a rectangular plate as a whole.

In the following description, the direction in which the single cells 90 are stacked will be referred to as a first direction X.

Also, the directions in which the long sides and the short sides of the single cell 90 extend will be respectively referred to as a second direction Y and a third direction Z.

The single cell 90 includes supply-side manifold holes 94, 95, 96 for introducing fuel gas, coolant, and oxidant gas into the single cell 90. Further, the single cell 90 includes discharge-side manifold holes 97, 98, 99 for discharging the fuel gas, the coolant, and the oxidant gas in the single cell 90 to the outside.

The supply-side manifold holes 94, 95, 96 and the discharge-side manifold holes 97, 98, 99 each extend in the first direction X through the single cell 90. The supply-side manifold hole 94 and the discharge-side manifold holes 98, 99 are provided on one side in the second direction Y of the single cell 90 (on the left side as viewed in FIG. 1). The discharge-side manifold hole 97 and the supply-side manifold holes 95, 96 are provided on the other side in the second direction Y of the single cell 90 (on the right side as viewed FIG. 1). The supply-side manifold hole 94 and the discharge-side manifold holes 98, 99 are arranged in that order in the third direction Z while being spaced apart from each other. The discharge-side manifold hole 97 and the supply-side manifold holes 95, 96 are arranged in that order in the third direction Z while being spaced apart from each other.

### Power Generating Unit 10

As shown in FIG. 1, the power generating unit 10 includes a solid polymer electrolyte membrane (not shown; hereinafter referred to as an electrolyte membrane) and electrodes 11, 12 respectively provided on opposite surfaces of the electrolyte membrane. In the present embodiment, the electrode that is joined to one side in the first direction X (the upper side as viewed in FIG. 1) of the electrolyte membrane (not shown) is a cathode 11. Also, the electrode joined to the other side in the first direction X (the lower side in the in FIG. 1) of the electrolyte membrane is an anode 12. The electrodes 11, 12 each include a catalyst layer (not shown) joined to the electrolyte membrane and a gas diffusion layer (not shown), which is joined to the catalyst layer.

### Frame Member 20

The frame member 20 is provided between the cathode-side separator 30 and the anode-side separator 40. The frame member 20 is a substantially rectangular plate elongated in the second direction Y. The frame member 20 is made of, for example, a plastic.

The frame member 20 includes supply-side manifold holes 24, 25, 26 and discharge-side manifold holes 27, 28, 29, which are respectively parts of the supply-side manifold holes 94, 95, 96 and the discharge-side manifold holes 97, 98, 99.

The frame member 20 includes an opening 21 in a center. The periphery of the power generating unit 10 is joined to the inner edge of the opening 21 from one side in the first direction X (from the upper side as viewed in FIG. 1).

### Cathode-Side Separator 30

As shown in FIG. 1, the cathode-side separator 30 is arranged to face the cathode 11 of the power generating unit 10. The cathode-side separator 30 includes a metal base (e.g., stainless steel) and a conductive layer that covers the surface of the base. The base of the cathode-side separator 30 is formed by stamping.

The cathode-side separator 30 includes supply-side manifold holes 34, 35, 36 and discharge-side manifold holes 37, 38, 39, which are respectively parts of the supply-side manifold holes 94, 95, 96 and the discharge-side manifold holes 97, 98, 99.

The cathode-side separator 30 includes a first surface 30a, which overlaps with the frame member 20 and the power generating unit 10, and a second surface 30b, which is a surface on a side opposite to the first surface 30a.

The cathode-side separator 30 includes groove passages 50, through which oxidant gas flows, and cooling passages 58, through which coolant flows. The groove passages 50 are provided in the first surface 30a. The cooling passages 58 are provided in the second surface 30b.

FIG. 1 illustrates, in a simplified manner, the outer edge of a portion that includes the groove passages 50 and the outer edge of a portion that includes the cooling passages 58.

### Anode-Side Separator 40

As shown in FIG. 1, the anode-side separator 40 is arranged to face the anode 12 of the power generating unit 10. The anode-side separator 40 includes a metal base (e.g., stainless steel) and a conductive layer that covers the surface of the base. The base of the anode-side separator 40 is formed by stamping.

The anode-side separator 40 includes supply-side manifold holes 44, 45, 46 and discharge-side manifold holes 47, 48, 49, which are respectively parts of the supply-side manifold holes 94, 95, 96 and the discharge-side manifold holes 97, 98, 99.

The anode-side separator 40 includes a first surface 40a, which overlaps with the frame member 20 and the power generating unit 10, and a second surface 40b, which is a surface on a side opposite to the first surface 40a.

The anode-side separator 40 includes groove passages 60, through which fuel gas flows, and cooling passages 68, through which coolant flows. The groove passages 60 are provided in the first surface 40a. The cooling passages 68 are provided in the second surface 40b.

FIG. 1 illustrates, in a simplified manner, the outer edge of a section in the anode-side separator 40 that includes the groove passages 60 and the outer edge of a section in the anode-side separator 40 that includes the cooling passages 68.

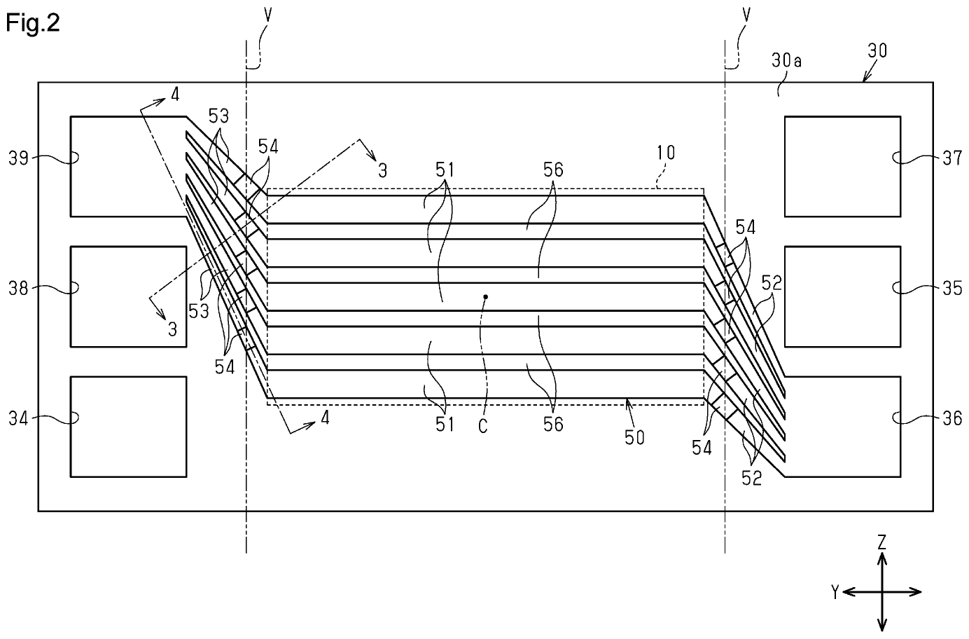

The configuration of the cathode-side separator 30 will now be described. FIG. 2 shows the state of the cathode-side separator 30 in FIG. 1 inverted vertically.

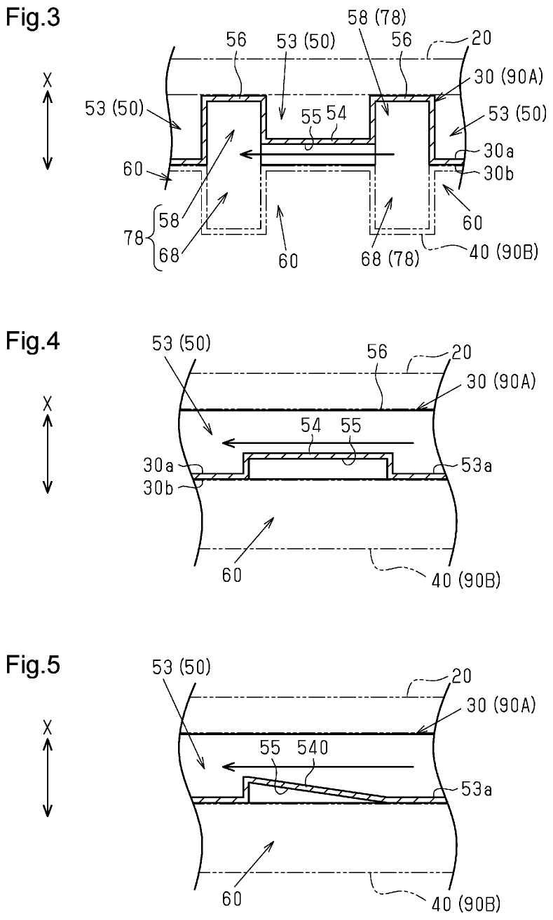

As shown in FIG. 2, the groove passages 50 connect the supply-side manifold hole 36 and the discharge-side manifold hole 39 to each other. Ribs 56 are provided between the groove passages 50 (see FIG. 3). The groove passages 50 include main passages 51, supply-side connecting passages 52, and discharge-side connecting passages 53. The main passages 51 face the power generating unit 10. The supply-side connecting passages 52 respectively connect the supply-side manifold hole 36 to the main passages 51. The discharge-side connecting passages 53 respectively connect the main passages 51 to the discharge-side manifold holes 39. Thus, oxidant gas is supplied from the supply-side manifold hole 36 to the main passages 51 through the supply-side connecting passages 52. The oxidant gas flowing through the main passages 51 is discharged to the discharge-side manifold holes 39 through the discharge-side connecting passages 53.

The supply-side connecting passages 52 and the discharge-side connecting passages 53 are symmetrical with respect to a center C in a planar direction of the cathode-side separator 30. As such, in the following description, the configuration of the discharge-side connecting passages 53 will be described, and the configuration of the supply-side connecting passages 52 may be omitted in some cases.

As shown in FIG. 2, the discharge-side connecting passages 53 each have a protrusion 54 that protrudes toward the power generating unit 10. Each protrusion 54 is partially provided in an extending direction of the corresponding discharge-side connecting passage 53. The supply-side connecting passages 52 and the discharge-side connecting passages 53 each have a protrusion 54. Each protrusion 54 extends over the entire width of the corresponding discharge-side connecting passage 53. The discharge-side connecting passages 53 each have the protrusion 54. In the present embodiment, the protrusions 54 are located on an imaginary line V extending in the third direction Z.

FIG. 3 shows cooling passages 78 defined by the cathode-side separator 30 and the anode-side separator 40 of another single cell 90 (hereinafter, referred to as the single cell 90B) that is adjacent to the single cell 90 (hereinafter, referred to as the single cell 90A) including the cathode-side separator 30.

Each cooling passage 58 of the cathode-side separator 30 is located between an adjacent pair of the groove passages 50. Each cooling passage 68 of the anode-side separator 40 is located between an adjacent pair of the groove passages 60.

Each cooling passage 58 of the cathode-side separator 30 and the corresponding cooling passage 68 of the anode-side separator 40 form a cooling passage 78.

As shown in FIGS. 3 and 4, the second surface 30b of the cathode-side separator 30 includes grooves 55 formed by the protrusions 54. Each groove 55 connects an adjacent pair of the cooling passages 58 to each other.

As shown in FIG. 4, the protruding amount of each protrusion 54 from the bottom surface 53a of the discharge-side connecting passage 53 is constant in the extending direction of the discharge-side connecting passage 53.

Operation of the present embodiment will now be described.

The protrusions 54 increase the rigidity of the supply-side connecting passages 52 and the discharge-side connecting passages 53.

As indicated by the arrow in FIG. 3, coolant flows from one of the cooling passages 58 that are adjacent to each other to the other cooling passage 58 through the groove 55. The cooling passage 58 and the groove 55 are thus cooled by the coolant.

The present embodiment has the following advantages.

(1) The supply-side connecting passages 52 and the discharge-side connecting passages 53 each have a protrusion 54, which protrudes toward the power generating unit 10. Each protrusion 54 is partially provided in the extending direction of the corresponding connecting passage.

This configuration operates in the above-described manner and thus limits warpage of the cathode-side separator 30.

(2) Each protrusion 54 extends over the entire width of the corresponding one of the supply-side connecting passages 52 and the discharge-side connecting passage 53.

With this configuration, the protrusions 54 further increase the rigidity of the supply-side connecting passages 52 and the discharge-side connecting passages 53. This further limits warpage of the cathode-side separator 30.

(3) The protrusions 54 are provided in all of the supply-side connecting passages 52 and the discharge-side connecting passages 53.

With this configuration, the protrusions 54 increase the rigidity of each of the supply-side connecting passages 52 and the discharge-side connecting passages 53. This further limits warpage of the cathode-side separator 30.

(4) The supply-side connecting passages 52 and the discharge-side connecting passages 53 each have a protrusion 54.

With this configuration, the protrusions 54 increase the rigidity of both of the supply-side connecting passages 52 and the discharge-side connecting passages 53. This further limits warpage of the cathode-side separator 30.

(5) The supply-side connecting passages 52 and the discharge-side connecting passages 53 are symmetrical with respect to the center C in the planar direction of the cathode-side separator 30.

This configuration improves the rigidity of the cathode-side separator 30 in a well-balanced manner about the center C in the planar direction of the cathode-side separator 30. This further limits warpage of the cathode-side separator 30.

(6) Each cooling passage 58 of the cathode-side separator 30 is located between an adjacent pair of the connecting passages 52, 53. Each protrusion 54 extends over the entire width of the corresponding connecting passage 52, 53. The second surface 30b includes the grooves 55, each of which is formed by a protrusion 54 and connects an adjacent pair of the cooling passages 58 to each other.

With this configuration, the protrusions 54 provided in the connecting passages 52, 53 form the grooves 55, each of which connects an adjacent pair of the cooling passages 58 to each other. Coolant flowing through the cooling passages 58 flows through the grooves 55. The grooves 55 increase the surface area of the cooling passages 58. This improves the cooling efficiency of the fuel cell stack.

### Modifications

The above-described embodiment may be modified as follows. The above-described embodiment and the following modifications can be combined as long as the combined modifications remain technically consistent with each other.

As shown in FIG. 5, the protruding amount of a protrusion 540 may be increased toward the downstream side in the flow direction of oxidant gas. This limits an increase in the pressure loss of oxidant gas caused by the protrusion 540.

In the above-described embodiment, a gap is provided between each groove 55 of the cathode-side separator 30 and the anode-side separator 40 of the single cell 90B different from the single cell 90A having the cathode-side separator 30, but the present disclosure is not limited to this. A portion of the anode-side separators 40 of the other single cell 90B that faces the groove 55 may be brought into contact with the entire bottom surface of the groove 55 so as to eliminate the above-described gap.

In the above-described embodiment, the supply-side connecting passages 52 and the discharge-side connecting passages 53 are symmetrical with respect to the center C in the planar direction of the cathode-side separator 30. However, the present disclosure is not limited to this. The supply-side connecting passages 52 and the discharge-side connecting passages 53 may be asymmetrical with respect to the center C in the planar direction of the cathode-side separator 30.

The protrusions 54 of either the supply-side connecting passages 52 or the discharge-side connecting passages 53 may be omitted. Even in this case, of the supply-side connecting passages 52 and the discharge-side connecting passages 53, the rigidity of the connecting passages with the protrusions 54 is increased.

In the above-described embodiment, all the supply-side connecting passages 52 are provided with the protrusions 54. However, the present disclosure is not limited to this. It is sufficient for the protrusion 54 to be provided in at least one of the supply-side connecting passages 52. Even in this case, the rigidity of the supply-side connecting passage 52 that is provided with the protrusion 54 is increased. The same applies to the discharge-side connecting passages 53.

In the above-described embodiment, each protrusion 54 extends over the entire width of the corresponding supply-side connecting passage 52. However, the present disclosure is not limited to this. The protrusion 54 may be partially provided in the width direction of the supply-side connecting passage 52. The same applies to the discharge-side connecting passages 53.

In addition to or in place of the cathode-side separator 30, the anode-side separator 40 may be provided with protrusions 54.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A separator for a fuel cell, the separator being configured to face a power generating unit of the fuel cell, the separator comprising:
multiple main passages configured to face the power generating unit and allow reactant gas to flow through the main passages;
a supply-side manifold hole configured to supply the reactant gas toward the main passages;
a discharge-side manifold hole configured to discharge the reactant gas from the main passages;
multiple supply-side connecting passages that connect the supply-side manifold hole and the main passages to each other; and
multiple discharge-side connecting passages that connect the discharge-side manifold hole and the main passages to each other,
wherein at least one of the supply-side connecting passages and the discharge-side connecting passages has a protrusion that protrudes toward the power generating unit, the protrusion being partially provided in an extending direction of the connecting passage.

2. The separator for the fuel cell according to claim 1, wherein the protrusion is arranged over an entire width of the corresponding connecting passage.

3. The separator for the fuel cell according to claim 1, wherein all the supply-side connecting passages, all the discharge-side connecting passages, or all the supply-side and discharge-side connecting passages each have the protrusion.

4. The separator for the fuel cell according to claim 1, wherein at least one of the supply-side connecting passages and at least one of the discharge-side connecting passages each have the protrusion.

5. The separator for the fuel cell according to claim 4, wherein
the supply-side connecting passages and the discharge-side connecting passages each have the protrusion, and
the supply-side connecting passages and the discharge-side connecting passages are symmetrical with respect to a center in a planar direction of the separator for the fuel cell.

6. A fuel cell stack, comprising stacked single cells, each single cell including a power generating unit, a first separator, and a second separator, the first and second separators holding the power generating unit between the first and second separators, wherein
the first separator of each single cell is adjacent to the second separator of another single cell, at least one of the first separator and the second separator being the separator for the fuel cell according to claim 1 and including a cooling passage on a surface opposite to a surface on which the main passages are provided, and the cooling passage being configured to allow coolant to flow through the cooling passage, wherein
the cooling passage is located between an adjacent pair of the connecting passages,
the protrusion is provided over an entire width of the at least one of the connecting passages, and
a groove is provided on the surface opposite to the surface on which the main passages are provided, the groove being formed by the protrusion and connecting an adjacent pair of the cooling passages to each other.
